(19) United States
(12) Patent Application Publication
(10) Pub. No.: US 2026/0044767 A1
(43) Pub. Date: Feb. 12, 2026

(54) QUANTUM COMPUTING WITH SPECTATOR QUBITS

(71) Applicant: THE UNIVERSITY OF CHICAGO, CHICAGO, IL (US)

(72) Inventors: Hannes Bernien, Chicago, IL (US); Kevin Singh, Chicago, IL (US); Shraddha Anand, Chicago, IL (US); Conor Bradley, Chicago, IL (US)

(21) Appl. No.: 19/101,512

(22) PCT Filed: Aug. 4, 2023
(86) PCT No.: PCT/US2023/029572

§ 371 Date: Feb. 5, 2025

Related U.S. Application Data
(60) Provisional application No. 63/371,341, filed on Aug. 12, 2022.

(51) Int. Cl. G06N 10/40

(52) U.S. Cl. CPC G06N 10/40

(57) ABSTRACT

A quantum-computing method includes executing a data quantum circuit with data qubits, all of which are of the same first type of quantum system having a first plurality of transitions. The quantum-computing method also includes executing a spectator quantum circuit with spectator qubits, all of which are of the same second type of quantum system having a second plurality of transitions. During execution of the spectator and data quantum circuits, the spectator qubits and data qubits are simultaneously driven with a coherent radiation field while the data qubits are in coherent superposition states. The radiation field is (i) far detuned from all of the first plurality of transitions and (ii) resonant with one of the second plurality of transitions. The first and second types of quantum system may be two different atomic species that can each be laser cooled and trapped, such as rubidium and cesium.

### RELATED APPLICATIONS

This application claims priority to U.S. Provisional Patent Application No. 63/371,341, filed on Aug. 12, 2022, which is incorporated herein by reference in its entirety.

### STATEMENT REGARDING FEDERALLY SPONSORED RESEARCH OR DEVELOPMENT

This invention was made with government support under FA9550-21-1-0209 awarded by the Air Force Office of Scientific Research, DE-FOA-0002253 awarded by the Department of Energy, N00014-20-1-2510 awarded by the Office of Naval Research, and 2016136 awarded by the National Science Foundation. The government has certain rights in the invention.

### BACKGROUND

In the fields of quantum computing, quantum information processing, and quantum metrology, the interaction of qubits with the environment may cause the qubits to decohere.

### SUMMARY

The present embodiments include systems and methods that perform quantum computing on data qubits utilizing co-located, auxiliary “spectator” qubits that act as in-situ probes of noise and systematic effects. Measurements of the spectator qubits can be used for real-time, coherent corrections of errors in the data qubits. As an experimental demonstration, an array of cesium spectator qubits was used to correct correlated phase errors on an array of rubidium data qubits. By combining in-sequence readout, data processing, and feed-forward operations, these correlated errors were suppressed within the execution of the quantum circuit. The protocol is broadly applicable to quantum information platforms, and establishes key tools for scaling neutral-atom quantum processors, including mid-circuit readout of atom arrays, real-time processing and feed-forward, and coherent mid-circuit reloading of atomic qubits.

### BRIEF DESCRIPTION OF THE FIGURES

FIG. 1 is a functional diagram of a quantum-computing system that performs mid-circuit readout of a plurality of spectator qubits to control a plurality of data qubits, in accordance with the embodiments.

FIG. 2A is an energy-level diagram of a first type of quantum system.

FIG. 2B is an energy-level diagram of a second type of quantum system.

FIG. 3 is a fluorescence image of spectator qubits (¹³³Cs) and data qubits (⁸⁷Rb) forming a dual-species atom array. The scale-bar indicates ˜10 μm.

FIG. 4 are plots showing microwave Rabi oscillations of the data qubits and spectator qubits. Dashed lines are fits to exponentially decaying sinusoids.

FIG. 5A is a pulse diagram depicting mid-circuit readout (MCR) of atomic qubits, in accordance with some of the present embodiments. The lower-case and upper-case letters indicate π/2 and π pulses, respectively, along that axis of rotation. The readout light is left on for the remainder of the sequence after MCR.

FIG. 5B is a plot showing measurements of spectator-qubit dynamics while preserving data-qubit coherence. During an XY8 decoupling sequence on the data qubits (diamonds), we performed an XY4 decoupling sequence and subsequent projective measurement on the spectator qubits. The data-qubit coherence \sqrt{ [symbol]σₓ [symbol] ²+ [symbol] σ_{y} [symbol] ²} was unchanged in the absence of MCR (circles). The dashed lines are fits [29]. The inset shows coherence measurements for early (square) and late (triangle) evolution times.

FIG. 5C is an example fluorescence histogram of a spectator qubit. Solid lines are fits to a bimodal Poisson distribution.

FIG. 5D is a cumulative histogram of the discrimination infidelities of the spectator qubits during MCR [29].

FIG. 5E is a plot showing the coherence of spectator qubits. The measured spectator coherence time is

$${T}_{2}^{XY 4} = 0.136 ms . \qquad ( 7 )$$

FIG. 6A is a diagram illustrating how noise channels induce correlated phase errors (arrows) between the data qubits and spectator qubits. Measurement of the spectator qubits along the y-axis enables single-shot phase estimation, from which the phase accrued by the data qubits can be inferred and corrected in real-time.

FIG. 6B is a diagram depicting the gate sequence for MCR of correlated phase errors. The data and spectator qubits are synchronously decoupled and acquire correlated errors owing to magnetic field noise δB_{z}. The spectator-qubit decoupling sequence is truncated, with the remaining time assigned for mid-circuit readout and feed-forward.

FIG. 6C is an example coherence measurement of the data qubits at the end of the gate sequence shown in FIG. 6B, with the feed-forward turned on (squares) and off (triangles). The field noise applied at f_{AC}=36.2 Hz was 10.7 mG RMS. The dashed lines are fits, from which we extract [symbol] σₓ [symbol] =0.53(1) and 0.02(2), respectively.

FIG. 6D is a plot of the data-qubit expectation value [symbol] σₓ [symbol] as a function of the RMS noise strength at f_{AC}. The plot indicates the correctable range. The solid lines are the results of numerical simulations.

FIG. 6E is a plot of the data-qubit expectation value [symbol] σₓ [symbol] as a function of the noise frequency at 10.7 mG RMS. The plot indicates an absolute gain in the measured coherence. The solid lines are the results of numerical simulations.

FIG. 7A illustrates reloading of spectator qubits using a pulsed magneto-optical trap (MOT) while decoupling the data qubits, and therefore maintaining data qubit coherence. The data quibit coherence time is

$${T}_{2}^{XY 4} = 0.42 \qquad ( 3 )$$

s with the pulsed MOT and

$${T}_{2}^{XY 4} = 0.45 s \qquad ( 1 )$$

without it. The spectator qubits are reloaded on a timescale of 150(50) ms (i.e., the time to reach 1−1/e of the asymptote), saturating at a loading fraction of 0.49.

FIG. 7B illustrates reloading of spectator qubits using polarization-gradient cooling (PGC) while decoupling the data qubits. The data qubit coherence time is

$${T}_{2}^{XY 8} = 0.64 s \qquad ( 5 )$$

with the PGC light and

$${T}_{2}^{XY 8} = 0.65 \qquad ( 2 )$$

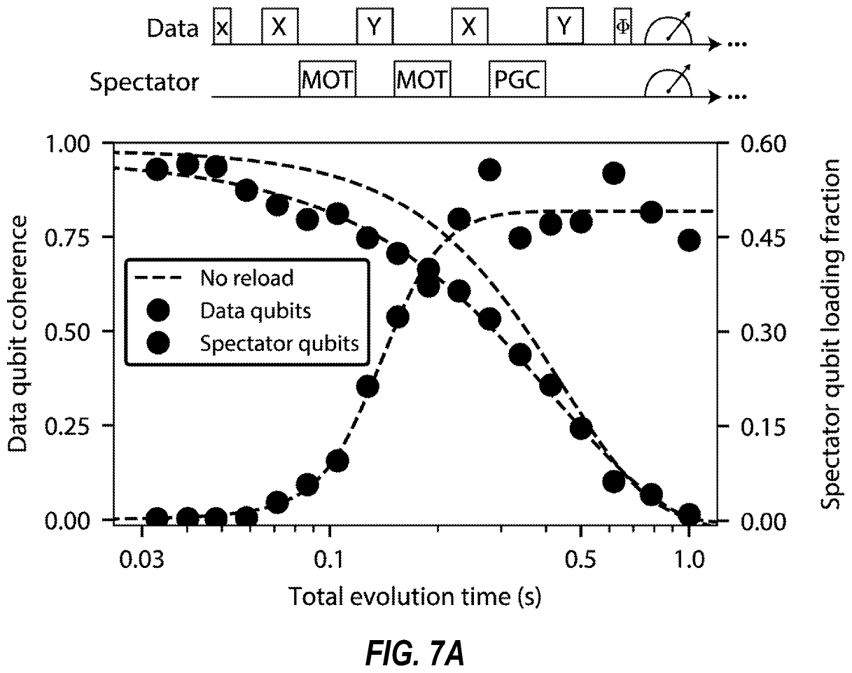

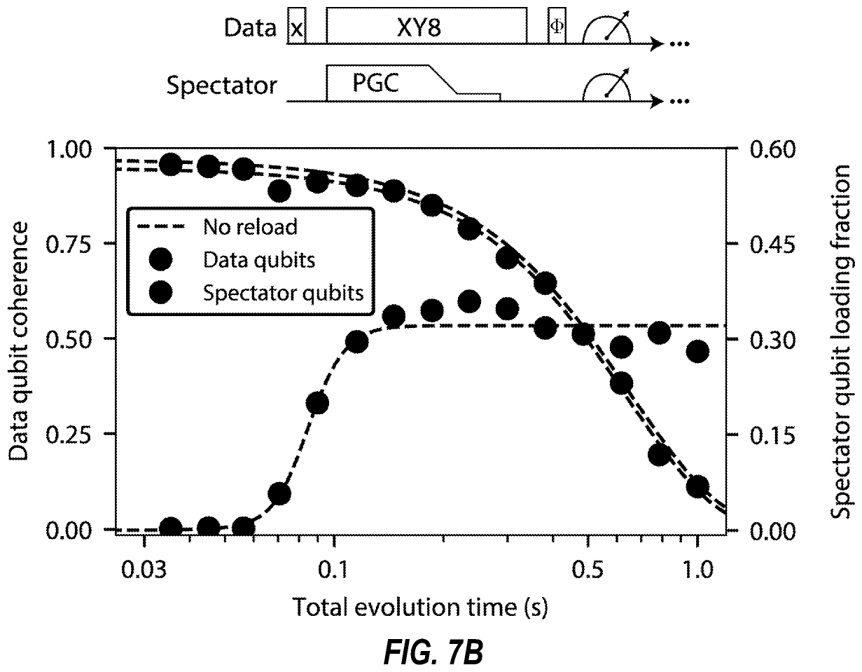

s without it. Reloading occurs on a faster timescale of 90(30) ms compared to FIG. 7A, saturating at a loading fraction of 0.32. The dashed lines are fits [29].

### DETAILED DESCRIPTION

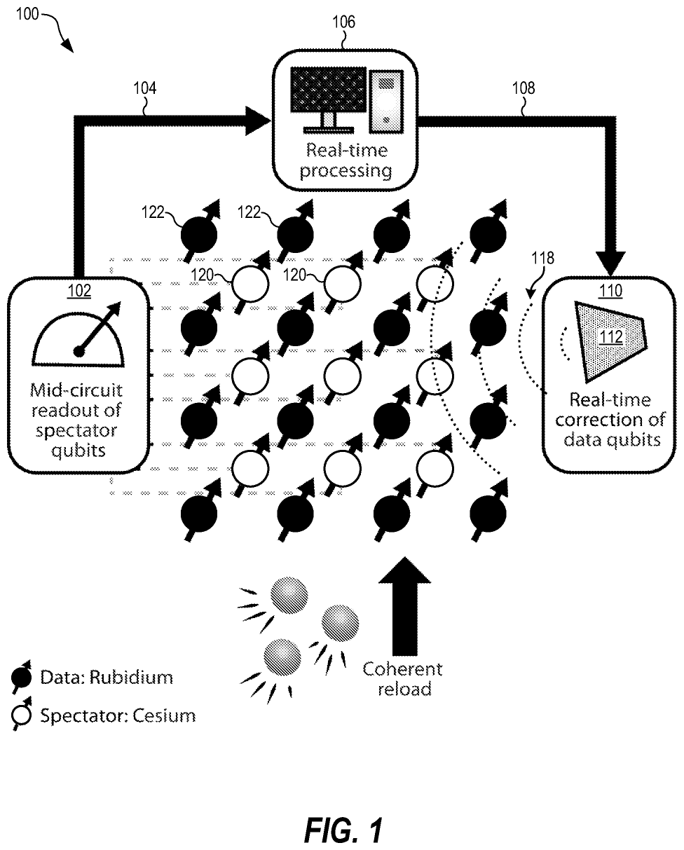

FIG. 1 is a functional diagram of a quantum-computing system 100 that performs mid-circuit readout of a plurality of spectator qubits 120 to control a plurality of data qubits 122, in an embodiment. The data qubits 122 are all of the same first type of quantum system while the spectator qubits 120 are all of the same second type of quantum system that is different from the first type. The quantum-computing system 100 includes a spectator-qubit controller 102 that executes one or more quantum circuits with the spectator qubits 120 and a data-qubit controller 110 that executes one or more quantum circuits with the data qubits 122. For clarity herein, a quantum circuit executed by the spectator-qubit controller 102 is also referred to as a “spectator quantum circuit” while a quantum circuit executed by the data-qubit controller 110 is also referred to as a “data quantum circuit.”

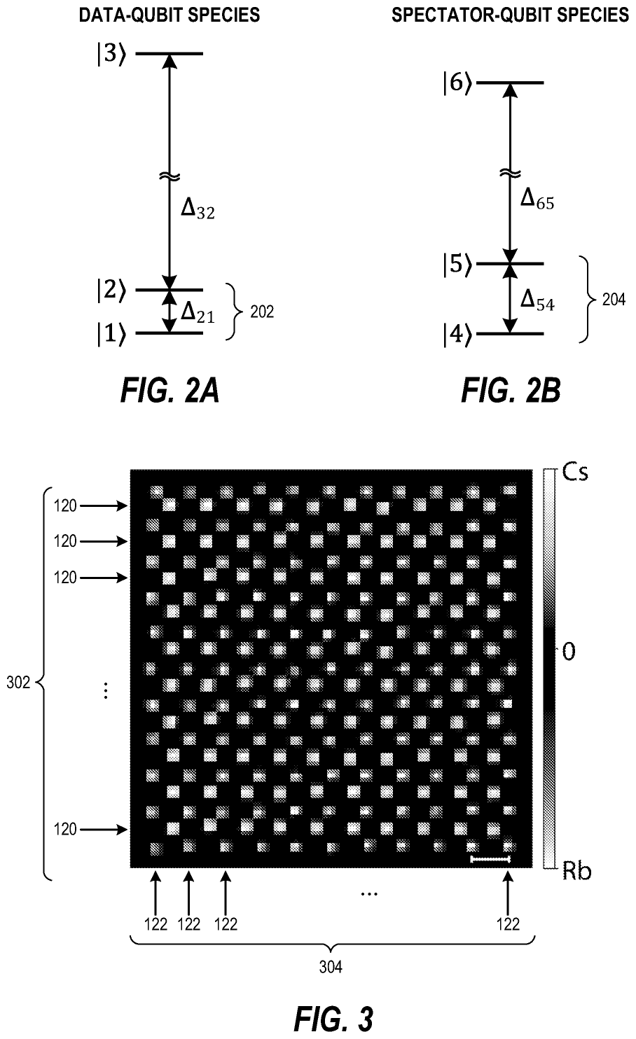

FIG. 2A is an energy-level diagram of the first type of quantum system, also referred to herein as the “data-qubit species.” The data-qubit species is a composite quantum system with several internal energy levels forming a first plurality of transitions. The internal energy levels include a first quantum state |1 [symbol] having a first energy ω₁, a second quantum state |2 [symbol] having a second energy ω₂, and a third quantum state |3 [symbol] having a third energy ω₃. It is assumed that the quantum states |1 [symbol] , |2 [symbol] , and |3 [symbol] have distinct energies and are therefore non-degenerate. The quantum states |1 [symbol] and |2 [symbol] form a first qubit 202, i.e., a two-level subsystem within which quantum information can be encoded. For this reason, the quantum states |1 [symbol] and |2 [symbol] are also referred to herein as “data qubit states.” The data qubit states |1 [symbol] and |2 [symbol] are separated in energy by a first spacing Δ₂₁=ω₂−ω₁.

The third quantum state |3 [symbol] can be electromagnetically coupled to the second quantum state |2 [symbol] by driving the |2 [symbol] +13) transition with coherent radiation whose frequency matches the transition energy Δ₃₂=ω₃−ω₂. Additionally or alternatively, the third quantum state |3 [symbol] can be electromagnetically coupled to the first quantum state |1 [symbol] by driving the |1 [symbol] ↔|3 [symbol] transition with coherent radiation whose frequency matches the transition energy Δ₃₁=ω₃−ω₁. Depending on the magnitudes of Δ₃₁ and Δ₃₂, the coherent radiation may lie in the microwave, millimeter-wave, terahertz, or optical (e.g., infrared, visible, radiation, etc.) regions of the electromagnetic spectrum. Since the third quantum state |3 [symbol] does not form the first qubit 202, it is also referred to herein as a “data auxiliary state.” While FIG. 2A shows the data auxiliary state |3 [symbol] lying above (i.e., having a higher energy than) the data qubit states |1 [symbol] and |2 [symbol] , the data auxiliary state |3 [symbol] may alternatively lie below or between the data qubit states |1 [symbol] and |2 [symbol] . The data-qubit species may have additional auxiliary states that can also be electromagnetically coupled to one or both of the data qubit states |1 [symbol] and |2 [symbol] .

In one example, the data-qubit species is ⁸⁷Rb. Here, the data qubit states |1 [symbol] and |2 [symbol] may be magnetic sublevels of the F=1 and F=2 hyperfine levels, respectively, of the 5²S_{1/2} ground state. In this case, Δ₂₁≈6.8 GHz. The data auxiliary state |3 [symbol] may be a magnetic sublevel of a hyperfine level of the 5²P_{3/2} excited state (i.e., the D₂ transition at 780 nm, Δ₃₁≈Δ₃₂≈384.23 THz) or the 5²P_{1/2} excited state (i.e., the D₁ transition at 795 nm, Δ₃₁≈Δ₃₂≈377.11 THz). The data qubit states |1 [symbol] and |2 [symbol] may be different states of ⁸⁷Rb (e.g., Rydberg levels). Similarly, the data auxiliary state |3 [symbol] may be a different excited state of ⁸⁷Rb. Other examples of the data-qubit species are described below.

FIG. 2B is an energy-level diagram of the second type of quantum system, also referred to herein as the “spectator-qubit species.” The spectator-qubit species is a composite quantum system with several internal energy levels forming a second plurality of transitions. The internal energy levels include a fourth quantum state |4 [symbol] having a fourth energy ω₄, a fifth quantum state |5 [symbol] having a fifth energy ω₅, and a sixth quantum state |6 [symbol] having a sixth energy ω₆. It is assumed that the quantum states |4 [symbol] , |5 [symbol] , and |6 [symbol] have distinct energies and are therefore non-degenerate. The quantum states |4 [symbol] and |5 [symbol] form a second qubit 204, and therefore are also referred to herein as “spectator qubit states.” The spectator qubit states |4 [symbol] and |5 [symbol] are separated by a second energy spacing Δ₅₄=ω₅−ω₄.

The sixth quantum state |6 [symbol] can be electromagnetically coupled to the fifth quantum state |5 [symbol] by driving the |4 [symbol] +|5 [symbol] transition with coherent radiation whose frequency matches the transition energy Δ₆₅=ω₆−ω₅. Additionally or alternatively, the sixth quantum state |6 [symbol] can be electromagnetically coupled to the fourth quantum state |4 [symbol] by driving the |4 [symbol] +|6 [symbol] transition with coherent radiation whose frequency matches the transition energy Δ₆₄=ω₆−ω₄. Depending on the magnitudes of Δ₃₁ and Δ₃₂, the coherent radiation may lie in the microwave, millimeter-wave, terahertz, or optical regions of the electromagnetic spectrum. Since the sixth quantum state |6 [symbol] does not form the second qubit 204, it is also referred to herein as a “spectator auxiliary state.” While FIG. 2B shows the spectator auxiliary state |6 [symbol] lying above the spectator qubit states |4 [symbol] and |5 [symbol] , the spectator auxiliary state |6 [symbol] may alternatively lie below or between the spectator qubit states |4 [symbol] and |5 [symbol] . The spectator-qubit species may have additional auxiliary states that can also be electromagnetically coupled to one or both of the spectator qubit states |4 [symbol] and |5 [symbol] .

In one example, the spectator-qubit species in ¹³³Cs. Here, the spectator qubit states |4 [symbol] and |5 [symbol] may be two magnetic sublevels of the F=3 and F=4 hyperfine levels, respectfully, of the δ²S_{1/2} ground state. In this case, Δ₅₄ ˜9.2 GHz. The spectator auxiliary state |6 [symbol] may be a hyperfine level of the δ²P_{3/2} excited state (i.e., the D₂ transition at 852 nm, Δ₆₄≈A₆₅≈351.73 THz) or the δ²P_{1/2} excited state (i.e., the D₁ transition at 895 nm, Δ₆₄≈Δ₆₅≈335.12 THz). The spectator qubit states |4 [symbol] and |5 [symbol] may be other states of ¹³³Cs. Similarly, the spectator auxiliary state |6 [symbol] may be a different excited state of ¹³³Cs. Other examples of the spectator-qubit species are described below.

FIG. 3 is an example fluorescence image of data qubits 122 and spectator qubits 120. In FIG. 3, the data qubits 122 are ⁸⁷Rb atoms while the spectator qubits 120 are ¹³³Cs atoms. As shown in FIGS. 1 and 3, the data qubits 122 are trapped in a first optical lattice to form a data array 304 while the spectator qubits 120 are trapped in a second optical lattice to form a spectator array 302. The first and second optical lattices may be distinct optical lattices formed from trapping light of two different wavelengths. In this case, the first and second optical lattices may have different periodicities, trap depths, or both. Alternatively, the first and second optical lattices may be the same, in which case the data qubits 122 and spectator qubits 120 are trapped in different lattice sites. For clarity in FIGS. 1 and 3, not all of the data qubits 122 and spectator qubits 120 are labeled.

Each of the data array 304 and spectator array 302 may be one-dimensional, two-dimensional (as shown in FIGS. 1 and 3), or three-dimensional. The data array 304 and spectator array 302 may have different dimensionalities. For example, the data array 304 may be two-dimensional while the spectator array 302 is one-dimensional, or vice versa. Furthermore, it is not necessary for the data array 304 and spectator array 302 to lie in parallel planes. For example, when the data array 304 is a two-dimensional array lying in an x-y plane, the spectator array 302 may be a one- or two-dimensional array lying in the x-z plane, the y-z plane, or a plane that forms an oblique angle with the x-y plane.

It is not necessary for the spectator qubits 120 and data qubits 122 to form arrays provided that the spectator qubits 120 are proximate to the data qubits 122, where the term “proximate” means that the spectator qubits 120 are close enough to the data qubits 122 to sense external fields or other environmental effects that can cause the data qubits 122 to decohere. Where the data qubits 122 and spectator qubits 120 do form arrays, the data array 304 may fully overlap the spectator array 302, as shown in FIGS. 1 and 3. Alternatively, the data array 304 may only partially overlap the spectator array 302. Alternatively, there may be no spatial overlap between the data array 304 and spectator array 302.

One aspect of the present embodiments is the realization that the data qubits 122 and spectator qubits 120 can be coherently controlled independently of each other when the first and second energy spacings are sufficiently different (i.e., Δ₂₁ ≠Δ₅₄). Specifically, the data qubit states |1 [symbol] and |2 [symbol] and spectator qubit states |4 [symbol] and |5 [symbol] may be long-lived, and therefore each of the |1 [symbol] ↔|2 [symbol] and |4 [symbol] ↔|5 [symbol] transitions has a narrow linewidth. The difference between the first and second energy spacings is large enough that resonantly driving the |1 [symbol] |2 [symbol] transition in all of the data qubits 122 with a single coherent radiation field negligibly perturbs the quantum states of the spectator qubits 120 even though the spectator qubits 120 are also exposed to the same coherent radiation field. Similarly, resonantly driving the |4 [symbol] ↔|5 [symbol] transition negligibly perturbs the quantum states of the data qubits 122.

Another aspect of the present embodiments is the realization that the data qubits 122 and spectator qubits 120 can also be controlled independently of each other when the |1 [symbol] ↔|3 [symbol] and |2 [symbol] ↔|3 [symbol] transitions both have energies different from the |4 [symbol] ↔|6 [symbol] and |5 [symbol] ↔|6 [symbol] transitions. It is known in the art that auxiliary states are used for a variety of control and measurement operations in quantum computing, quantum information processing, and quantum metrology. For example, the data auxiliary state |3 [symbol] may be used for optically pumping the data qubits 122 into one of the data qubit states |1 [symbol] and |2 [symbol] . In another example, shelving is used with the data auxiliary state 13) to perform imaging of the data qubits 122 or to measure which of the data qubit states |1 [symbol] and |2 [symbol] one of the data qubits 122 is in. In yet another example, the data auxiliary state |3 [symbol] is used as an intermediate state for two-photon (or multi-photon) Raman processes. Other uses of auxiliary states include laser cooling (e.g., magneto-optical trapping, polarization gradient cooling, etc.) and repumping.

The difference between the transition energies Δ₃₂ and Δ₅₆ is large enough that resonantly driving the |2 [symbol] ↔|3 [symbol] transition in all of the data qubits 122 with a coherent radiation field (e.g., a laser beam) negligibly perturbs the quantum states of spectator qubits 120 even though the spectator qubits 120 are also exposed to the coherent radiation field. For this condition to occur, the data-qubit species and spectator-qubit species are selected such that the coherent radiation field, when resonant with the |2 [symbol] ↔|3 [symbol] transition, is far-detuned from any transition in the spectator-qubit species that couples to the qubit states |4 [symbol] and |5 [symbol] , including the |4 [symbol] ↔|6 [symbol] and |5 [symbol] ↔|6 [symbol] transitions. Similarly, when the coherent radiation field is resonant with the |1 [symbol] ↔|3 [symbol] transition, it is similarly far-detuned from any transition in the spectator-qubit species that couples to the qubit states |4 [symbol] and |5 [symbol] .

When the coherent radiation field is resonant with the |5 [symbol] ↔|6 [symbol] transition in the spectator qubits 120, the coherent radiation field is far-detuned from any transition in the data-qubit species that couples to the data qubit states |1 [symbol] and |2 [symbol] , including the |1 [symbol] ↔|3 [symbol] and |2 [symbol] ↔|3 [symbol] transitions. In this case, the coherent radiation field will negligibly perturb the quantum states of the data qubits 122. Similarly, when the coherent radiation field is resonant with the |4 [symbol] ↔|6 [symbol] transition in the spectator qubits 120, it is far-detuned from any transition in the data-qubit species, and therefore has a negligible effect on the quantum states of the data qubits 122.

Herein, the coherent radiation field “resonantly drives” a transition in a quantum system when the frequency of the coherent radiation field (also referred to as the “drive frequency”) is near the resonant frequency of the transition. Equivalently, the coherent radiation field is “resonant” with the transition. However, this use of the word “resonant” is not limited to the case where the drive frequency is exactly equal to the resonant frequency. Rather, the terms “resonant” and “resonantly” are used herein to include the case where the drive frequency is detuned from the resonant frequency (either to the red or blue) by up to several linewidths (e.g., within 10 linewidths of the resonant frequency). The purpose of resonant driving is to use the coherent radiation field to alter the quantum state of the quantum system in a controlled, engineered manner (e.g., implementing quantum gates of a quantum circuit). By contrast, when the coherent radiation field is “far-detuned” or “off-resonant” from the transition, it drives the transition so weakly that its effect on the quantum system can be ignored.

As an example of a data-qubit species and spectator-qubit species that have energy-level structures sufficiently different to allow for independent control and measurement of the data qubits 122 and spectator qubits 120, consider again the case of ⁸⁷Rb for the data qubits 122 and ¹³³Cs for the spectator qubits 120. Using the same ground-state hyperfine levels for the qubits states |1 [symbol] , |2 [symbol] , |4 [symbol] , and |5 [symbol] , as described above, consider a first laser beam that resonantly drives the D₂ transition at 780 nm (Δ₂₃≈384.23 THz) in ⁸⁷Rb, for which the data auxiliary state |3 [symbol] is a hyperfine level of the 5²P_{3/2} excited state. Also consider a second laser beam that resonantly drives the D₂ transition at 852 nm (Δ₅₆≈351.73 THz) in ¹³³Cs, for which the spectator auxiliary state |6 [symbol] is a hyperfine level of the δ²P_{3/2} excited state. When the data qubits 122 and spectator qubits 120 are proximate to each other (e.g., spatially interspersed), the first laser beam illuminates all of the qubits 120 and 122. Similarly, the second laser beam illuminates all of the qubits 122 and 120. The first and second laser beams may illuminate all of the qubits 122 and 120 simultaneously or sequentially.

While the first laser beam resonantly drives the rubidium D₂ transition in the data qubits 122, it will also off-resonantly drive the cesium D₂ transition in the spectator qubits 120. The strength of this off-resonant drive depends, in part, on the detuning of the first laser beam relative to the frequency of the cesium D₂ transition. In this case, the detuning of 384.23 THz−351.73 THz=32.5 THz, as compared to the ˜5.2 MHz linewidth of the cesium D₂ transition, is equivalent to over 6,000 linewidths. This detuning is so large that the first laser beam has a negligible effect on the spectator qubits 120. Specifically, the first laser beam drives the |4 [symbol] +|6 [symbol] and |5 [symbol] +|6 [symbol] transitions in ¹³³Cs so weakly that it has essentially no effect on the quantum state of the second qubit 204.

The first laser beam may also non-resonantly couple the spectator qubit states |4 [symbol] and |5 [symbol] to other auxiliary states of ¹³³Cs. For example, the detuning of the first laser beam relative to the cesium D₁ transition at 895 nm is 384.23 THz−335.12 THz=32.5 THz, or more than 9,000 linewidths. The detuning is even larger for transitions to higher-energy auxiliary states in ¹³³Cs. Therefore, even when these additional auxiliary states are considered, the first laser beam still has essentially no effect on the quantum state of the second qubit 204.

While the second laser beam resonantly drives the cesium D₂ transition in the spectator qubits 120, it also off-resonantly drives the rubidium D₂ transition in the data qubits 122. The strength of this off-resonant drive depends, in part, on the detuning of the second laser beam relative to the frequency of the rubidium D₂ transition. In this case, the magnitude of the detuning is the same 32.5 THz as above. Compared to the ˜6.0 MHz linewidth of the rubidium D₂ transition, this detuning is equivalent to over 5,000 linewidths, so large that the second laser beam has a negligible effect on the data qubits 122. Specifically, the second laser beam drives the |1 [symbol] +|3 [symbol] and |2 [symbol] +|3 [symbol] transitions in ⁸⁷Rb so weakly that it has a negligible effect on the quantum state of the first qubit 202.

The second laser beam may also non-resonantly couple the data qubit states |1 [symbol] and |2 [symbol] to other data auxiliary states of ⁸⁷Rb. For example, the detuning of the second laser beam relative to the rubidium D₁ transition at 795 nm is 377.11 THz−351.73 THz=25.38 THz, more than 4,000 linewidths. The detuning is even larger for transitions to higher-energy auxiliary states in ⁸⁷Rb. Therefore, even when these additional auxiliary states are considered, the second laser beam has essentially no effect on the quantum state of the first qubit 202.

Aside from ⁸⁷Rb and ¹³³Cs, any other atomic species that can be laser cooled may be used for the data-qubit species or spectator-qubit species. Accordingly, such atomic species are examples of the first type of quantum system and the second type of quantum system. Examples of such atomic species include, but are not limited to, alkali metals (e.g., lithium, sodium, potassium, etc.), alkaline-earth metals (e.g., magnesium, strontium, calcium, etc.), noble gases (e.g., helium, neon, argon, etc.), lanthanides (e.g., dysprosium, holmium, erbium, etc.), ytterbium, chromium, and mercury. The data qubits 122 and spectator qubits 120 may be neutral atoms or ions. While the above example uses ⁸⁷Rb as the data-qubit species and ¹³³Cs as the spectator-qubit species, these species can be swapped, i.e., ⁸⁷Rb can be the spectator-qubit species and ¹³³Cs can be the data-qubit species.

For a given atomic species, any isotope may be used. Thus, in the above examples, ⁸⁵Rb may be used instead of ⁸⁷Rb. In other embodiments, the data-qubit species and spectator-qubit species are two different isotopes of the same species. For example, ⁸⁵Rb can be the data-qubit species and ⁸⁷Rb can be the spectator-qubit species (or vice versa). In this case, the transition energies Δ₂₃ and Δ₁₃ are mush closer to the transition energies Δ₅₆ and Δ₄₆, typically differing by an isotope shift of a few gigahertz (as compared to tens of terahertz for the above example of ⁸⁷Rb and ¹³³Cs). Because these transition energies between the two isotopes are closer, it is more challenging to resonantly drive one isotope without significantly affecting the quantum states of the other isotope. Nevertheless, the difference of a few gigahertz is still sufficient to successfully implement certain operations using the present embodiments.

As an alternative to atomic species, one or both of the data-qubit species and spectator-qubit species may be a molecular species. For example, certain molecules (e.g., CaF, SrF) can be laser cooled and trapped. In another example, the molecular species are metal-ligand coordination complexes embedded with a host matrix. As another alternative to atomic species, one or both the data-qubit species and spectator-qubit species may be a defect and color center in a crystal. Examples include, but are not limited to, nitrogen-vacancy centers in diamond, rare-earth ions embedded in thin-film crystals (e.g., erbium ions embedded in titanium dioxide), silicon carbide color centers, and silicon nitride color centers. As another alternative to atomic species, one or both of the data-qubit species and spectator-qubit species may be a species of quantum dot (e.g., InGaAs, GaAs, CdSe, etc.).

To execute a data quantum circuit, the data-qubit controller 110 includes devices and instrumentation for manipulating and measuring the data qubits 122, as dictated by the data quantum circuit. Examples of such devices and instrumentation include, but are not limited to, lasers, microwave sources, and detectors (e.g., CCD camera). For example, the data-qubit controller 110 is shown in FIG. 1 with a microwave source 112 that emits a coherent microwave field 118 (shown as wavefronts) that simultaneously illuminates the data qubits 122 and spectator qubits 120. The coherent microwave field 118 resonantly drives the data qubits 122 while off-resonantly driving the spectator qubits 120. Although not shown in FIG. 1, the data-qubit controller 110 may additionally or alternatively include a laser that emits a laser beam that simultaneously illuminates the data qubits 122 and spectator qubits 120. This laser beam resonantly drives the data qubits 122 while off-resonantly driving the spectator qubits 120.

To execute a spectator quantum circuit, the spectator-qubit controller 102 includes devices and instrumentation for manipulating and measuring the spectator qubits 120, as dictated by the spectator quantum circuit. Examples of such devices and instrumentation include, but are not limited to, lasers, microwave sources, and detectors (e.g., CCD camera). For example, the spectator-qubit controller 102 may include a microwave source similar to the microwave source 112 except that it emits a coherent microwave field that is resonant with the spectator qubits 120 rather than the data qubits 122. Additionally or alternatively, the spectator-qubit controller 102 may include a laser that emits a laser beam that simultaneously illuminates the data qubits 122 and spectator qubits 120. This laser beam resonantly drives the spectator qubits 120 while off-resonantly driving the data qubits 122.

Since the benefits of quantum computing arise from the use of coherent superposition states, it is assumed that each of the data qubits 122 will be in a coherent superposition (i.e., linear combination) of the data qubit states |1 [symbol] and |2 [symbol] for at least some portion of the data quantum circuit. In the present embodiments, the spectator quantum circuit includes the step of simultaneously illuminating the data qubits 122 and spectator qubits 120 with a coherent radiation field that resonantly drives the spectator qubits 120 and non-resonantly drives the data qubits 122. When this step occurs during the data quantum circuit and one or more of the data qubits 122 are in a coherent superposition state, the non-resonant driving of the data qubits 122 will have negligible impact on their coherence. Advantageously, this allows the spectator qubits 120 to be controlled—and therefore the spectator quantum circuit to be executed—without impacting execution of the data quantum circuit (e.g., without degrading the fidelity of a quantum gate of the data quantum circuit).

Similarly, it is also assumed that each of the spectator qubits 120 will be in a coherent superposition of the spectator qubit states |4 [symbol] and |5 [symbol] for at least some portion of the spectator quantum circuit. In some of the present embodiments, the data quantum circuit includes the step of simultaneously illuminating the data qubits 122 and spectator qubits 120 with an additional coherent radiation field that resonantly drives the data qubits 122 and non-resonantly drives the spectator qubits 120. When this step occurs during the spectator quantum circuit and one or more of the spectator qubits 120 are in a coherent superposition state, the non-resonant driving of the spectator qubits 120 will have negligible impact on their coherence. Advantageously, this allows the data qubits 122 to be controlled—and therefore the data quantum circuit to be executed—without impacting execution of the spectator quantum circuit (e.g., the fidelity of a gate of the spectator quantum circuit).

In some embodiments, the spectator quantum circuit includes a step of measuring the spectator qubits 120. Such measurements may be performed, for example, via fluorescence detection or fluorescence imaging (e.g., with a CCD camera). In any case, the instrumentation needed to perform such measurements may be considered as part of the spectator-qubit controller 102, in which case the spectator-qubit controller 102 may output spectator-qubit measurement data 104 that includes the outcomes of such measurements. The quantum-computing system 100 may further include a processor 106 that processes the spectator-qubit measurements data 104 to generate control data 108. The data-qubit controller 110 may then control the data qubits 122 based on the control data 108.

A measurement of the spectator qubits 120 that is performed by the spectator-qubit controller 102 during execution of the data quantum circuit is also referred to herein as a “mid-circuit readout.” In some embodiments, the data-qubit controller 110 controls the data qubits 122, based on the control data 108, before execution of the data quantum circuit has finished. Such control of the data qubits 122 is labeled “feed-forward”. In embodiments that perform feed-forward operations, the data quantum circuit and spectator quantum circuit may be thought of as two branches, or sub-circuits, of a single larger quantum circuit that is executed with both the data qubits 122 and spectator qubits 120. The two branches interact with each other via the feed-forward control, thereby allowing the quantum states of the spectator qubits 120 to influence the measurement results of the data qubits 122.

While FIG. 1 shows the quantum-computing system 100 performing feed-forward control of the data qubits 122, other embodiments of the quantum-computing system 100 operate without feed-forward control. For example, as part of the data quantum circuit, the data qubits 122 may be measured to obtain data-qubit measurement data. The spectator-qubit measurement data 104 may then be post-processed to correct the data-qubit measurement data.

### Experimental Demonstration

Realizing large-scale programmable quantum systems that can overcome inevitable noise sources is a central challenge for modern physics [1, 2]. Environmental noise and experimental parameter drift necessitate strategies to reduce their impact and overcome resulting qubit errors. Although quantum error correction may ultimately be required, achieving the necessary qubit operation fidelities is an outstanding challenge for present quantum computing platforms [3-9]. Moreover, the effectiveness of error correction codes is reduced by correlated errors [10, 11], which may naturally occur when the qubits are in close spatial proximity or are controlled by shared hardware [12-16].

To address these challenges, several techniques have been developed to mitigate the effects of noise, such as composite pulses [17], optimal control [18], dynamical decoupling [17, 19], Hamiltonian learning [20], and machine-learning-based control engineering [21]. While successful, these techniques are typically tailored to specific noise models or require careful calibration, and thus face challenges when employed in realistic, fluctuating environments. For example, dynamical decoupling generates a filter function that mitigates a particular spectrum of noise, with pass-bands remaining that are not suppressed [22]. Additionally, it is only effective if the correlation time of the noise is long with respect to the interpulse delay.

Recent theoretical work has proposed a complementary technique based on “spectator” qubits (see the spectator qubits 120 of FIG. 1): additional qubits that are co-located with the computational “data” qubits (see the data qubits 122 of FIG. 1) and are susceptible to the same noise sources. The spectator qubits 120 act as in-situ probes of that noise such that measurement and feed-forward can be used to coherently protect the data qubits 122 during the execution of a quantum algorithm [23-25]. Notably, under two key conditions, spectator protocols are agnostic to the spectrum and correlation time of the noise source. First, the noise-induced dynamics must be correlated between the spectator and data qubits. Second, an estimate of those dynamics must be made by reading out the spectator qubits 120—and a subsequent feed-forward operation applied—much faster than the timescale over which the data and spectator qubits decorrelate. This second requirement has limited the experimental implementation of such protocols, as a significant number of measurements are required to reliably estimate the effects of a dynamic noise environment. Furthermore, the spectator-qubit readouts must be performed mid-circuit without perturbing the data qubits 122.

Here, we overcome these challenges and demonstrate real-time correction of correlated phase errors using a dual-species array of individually trapped neutral atoms. The protocol is outlined in FIG. 1. Data qubits 122 (rubidium) and spectator qubits 120 (cesium) are laser-cooled into optical tweezer arrays [26]. During logic operations on the data qubits, mid-circuit readouts on the array of ˜60 spectator qubits 120 enable single-shot estimation of globally correlated phase errors. The readout results are processed in real-time and used to infer the noise-induced phase accrued by the ˜60 data qubits 122. Crucially, owing to the crosstalk-free operation of the two species, these readouts do not disturb the coherence of the data qubits 122. We leverage a classical control architecture to perform in-sequence feed-forward, such that correlated errors on the data qubits are mitigated within the execution of the quantum circuit. Finally, we show that the spectator qubits 120 can be replenished within the data-qubit coherence time, an essential step towards repeated measurements and the continuous operation of atom-based quantum processors.

### Mid-Circuit Readout of Spectator Qubits

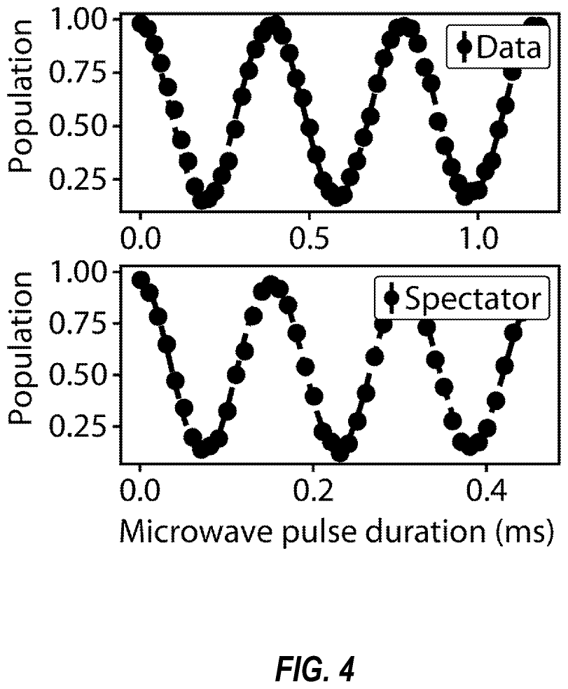

Our experiment is performed on arrays of 10×10 and 11×11 sites for the spectator qubits 120 and data qubits 122, respectively (see FIG. 3), which are stochastically loaded with an average loading fraction of ˜55%. The experimental apparatus has been upgraded from our previous work [26] to incorporate qubit initialization, manipulation, and readout, along with classical hardware to implement real-time processing and feed-forwarding. Here, the qubits are encoded into long-lived hyperfine states (|F=1, m_{F}, 0 [symbol] :=|0 [symbol] _{Rb} and |F=2, m_{F}=0:1 [symbol] :=|1 [symbol] _{Rb} for Rb; |F=3, m_{F}=0 [symbol] :=|0 [symbol] _{Cs} and |F=4, m_{F}=0 [symbol] :=|1 [symbol] _{Cs} for Cs). Microwave driving of the data qubits 122 and spectator qubits 120 after optical pumping into the states |1 [symbol] _{Rb} and |1 [symbol] _{Cs}, respectively, reveals coherent Rabi oscillations (see FIG. 4).

An essential ingredient for the spectator protocol is to perform mid-circuit readout (MCR) of the spectator qubits 120 without inducing additional data-qubit decoherence. This is challenging in single-species atom arrays because all atoms are resonant with the excitation laser and the measured qubits scatter light which can decohere the data qubits 122 via reabsorption. To overcome this, several ideas have been proposed and demonstrated, including coherently transporting qubits into readout cavities [27] and using additional shelving states to hide atoms from excitations from the readout light, as demonstrated for trapped ions [4]. However, realizing crosstalk-free imaging in large atom arrays has remained an outstanding challenge. A key motivation behind the dual-species approach is that the different atomic species have distinct optical transitions; measurements on one species are not expected to influence the other [26, 28].

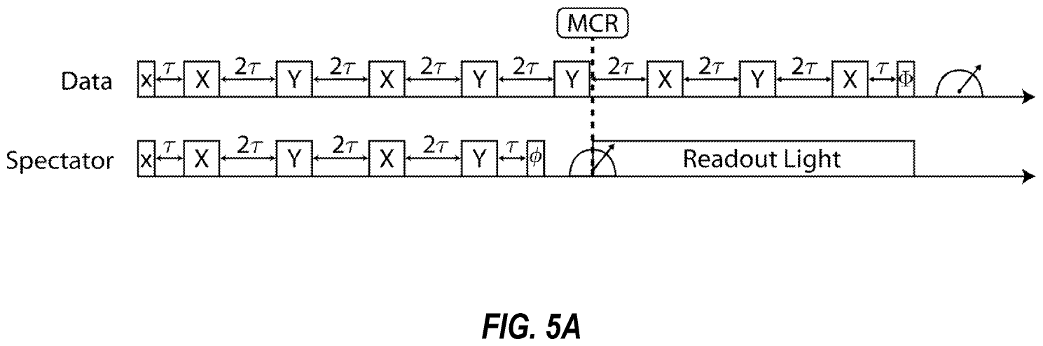

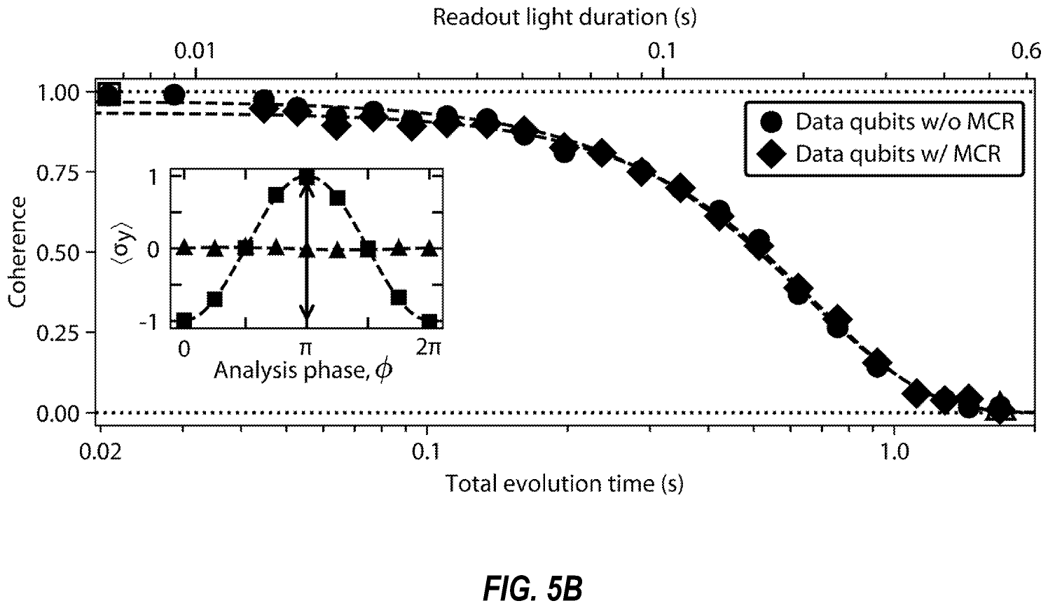

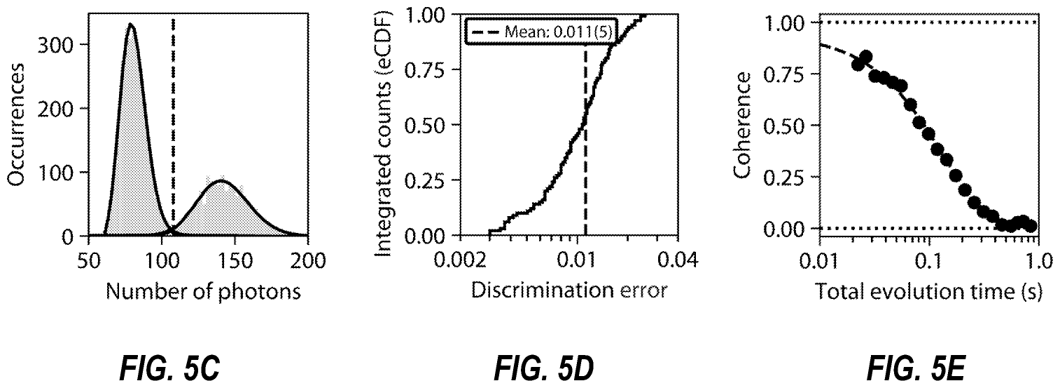

In a first experiment, we characterized the spectator-qubit mid-circuit readout, and measured its impact on the data-qubit coherence. The quantum circuit is shown in FIG. 5A. During an XY8 decoupling sequence on the data qubits 122, an XY4 sequence is performed on the spectator qubits 120. The spectator qubits 120 are measured within the XY8 sequence by selectively removing all atoms in the |1 [symbol] _{Cs} state via a resonant laser pulse and then fluorescence imaging for 15 ms. The coherence of the data qubits 122 and spectator qubits 120 as a function of their individual decoupling times are shown in FIGS. 5B and 5E, respectively. While the camera exposure time is fixed, the imaging light is applied for a variable time, 5τ (of a total of 16τ) in order to determine its effect on the data qubits 122. Crucially, the data qubit coherence time is unaltered by the

$$MCR ( fitted {T}_{2 , MCR}^{XY 8} = 0.68 ) s \qquad ( 1 )$$

$${T}_{2 , No MCR}^{XY 8} = 0.65 s ) . \qquad ( 2 )$$

The large detuning of the imaging light leads to negligibly low spontaneous scattering rates of ˜10⁻⁷ Hz. Moreover, spontaneous Raman scattering events which change these m_{F} states are further suppressed by a factor of 0.009 due to destructive interference of the off-resonant transition amplitudes [12]. The theoretical T₁ time from this decay channel is thus˜10⁸ s, resulting in a data-qubit bit-flip rate from readout crosstalk of ˜10⁻¹¹ during the 15-ms MCR. This readout duration was chosen to balance the requirements for achieving a high discrimination fidelity while minimizing the time for a feed-forward operation [29]. The discrimination fidelity of the spectator-qubit states (FIG. 5D) is extracted from a bimodal fit to the fluorescence histogram of each spectator qubit 120, as exemplified in FIG. 5C. Across the spectator array we find a mean fidelity of 0.989(5), showing that the spectator-qubit states are well-resolved by MCR.

### Spectator Protocol and Correction of Phase Errors

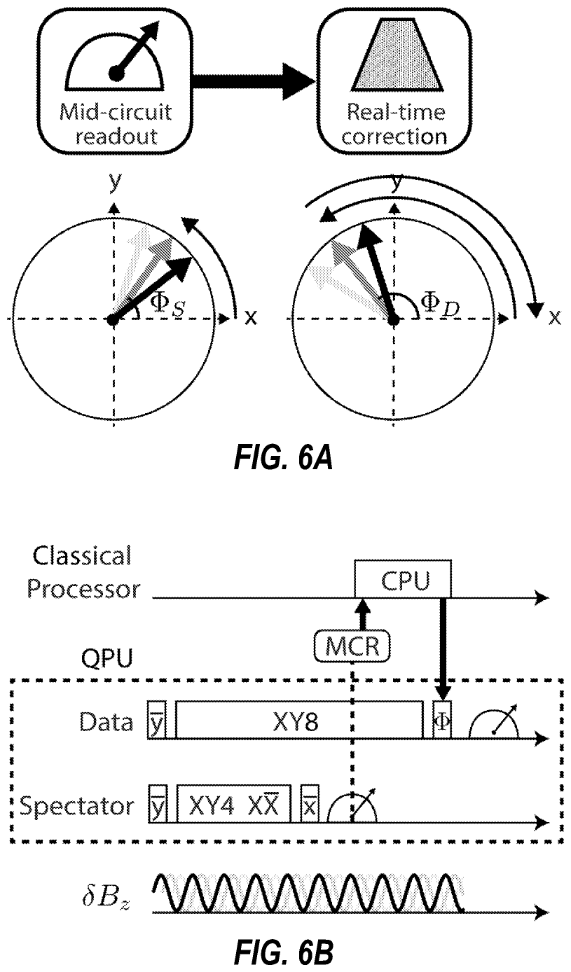

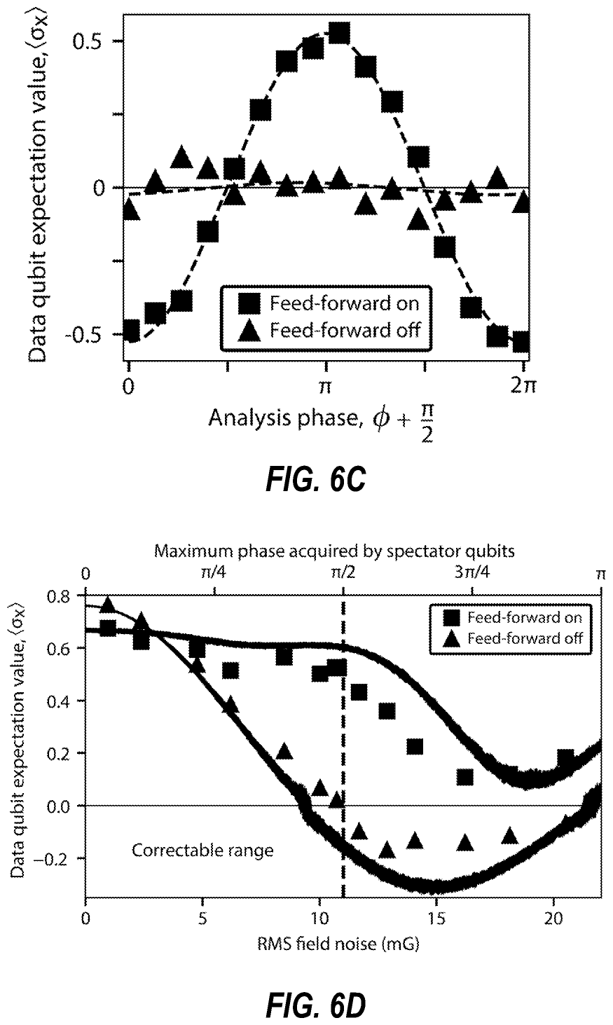

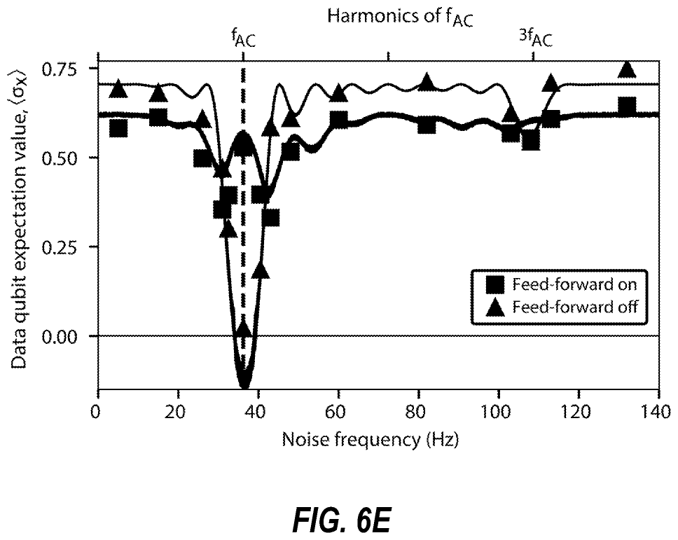

The preservation of data qubit coherence during spectator readout opens the possibility for feed-forward operations within a quantum circuit. Under simultaneous evolution, noise channels can induce correlated phase errors between the data and spectator qubits. Importantly, the large number of spectator qubits allows single-shot estimation of the acquired phase from one simultaneous MCR. The phase accrued by the data qubits can then be inferred and corrected in real-time, as illustrated in FIG. 6A.

To demonstrate this capability, we inject global magnetic field noise with amplitudes and frequencies comparable to those typically found in laboratory environments. The phase of the noise is random in each experimental repetition, without shot-to-shot temporal correlations. We focus on monochromatic noise for ease of synthesis and interpretation of protocol performance, but note that our scheme is generally agnostic to the noise spectrum. The pulse sequence for the experiment is shown in FIG. 6B. The data and spectator qubits undergo synchronous dynamical decoupling and acquire correlated errors from the common noise. Although the filter function of the CPMG-type dynamical decoupling sequence partially mitigates such noise, certain frequencies still couple into the sequence, occurring at odd-harmonics of f_{AC}=1/(4τ)=36.2 Hz, where 2τ is the time between π pulses [22]. The spectators sample this noise for three-quarters of the total evolution time of the data qubits, with the remainder of the time assigned for MCR and feed-forward. To achieve fast camera processing and feedback, we utilize a camera-linked classical control architecture for in-sequence processing of the fluorescence images, which in turn triggers an arbitrary-waveform-generator to perform real-time updates of the phase of the final data qubit π/2 pulse [29]. The phase update of this final π/2 pulse is equivalent to a z-axis qubit rotation, which is used to correct the noise-induced phase error on the data qubits.

To estimate the phase acquired by the spectators, Φ_{S}, MCR is performed along an axis orthogonal to the state preparation axis. Accordingly, the collective expectation value of the array can be inverted to give an estimate, Φ′_{S}=arcsin( [symbol] σ_{y} [symbol] /C), where C is a scaling factor describing the amplitude of the signal in the absence of injected noise [29]. The estimate Φ′_{S} is uniquely defined when the accrued phase lies within [−π/2,π/2], beyond which the protocol breaks down. The estimated noise-induced phase accrued by the data qubits 122 is given by Φ′_{D}=γβΦ′_{S}, where γ=4/3 is the ratio of the sensing times and β=1.35 is the ratio of the second-order Zeeman shifts of the clock states [29]. With this knowledge, a real-time correction can be applied.

We first probe the case for which the noise is maximally coupled, at f_{AC} (10.7 mG RMS). Without the spectator protocol, the random phase of the noise leads to complete dephasing of the data qubits. Strikingly, the feed-forward corrects the noise-induced phase in each experimental repetition, resulting in a recovery of the data qubit coherence (see FIG. 6C). The coherence as a function of the noise amplitude is shown in FIG. 6D. In stark contrast to the rapid decay observed in the absence of feed-forward, the spectator protocol robustly preserves coherence for field strengths below 11 mG. Beyond this value, the accrued phases on the spectator qubits can exceed ±π/2, where the protocol can no longer unambiguously detect phase errors.

Next, we study the dependence on the noise frequency for an RMS noise strength of 10.7 mG (see FIG. 6E). For a range of frequencies close to f_{AC}, real-time correction results in an absolute gain in the measured signal, shielding the data qubits from otherwise deleterious decoherence. A pair of small additional features occur near f_{AC} in the “feed-forward on” spectrum, arising from the finite spectator readout time, which leads to decorrelation between the data and spectator qubits. Reducing the fraction of time used for MCR would suppress these effects. Outside this region, feed-forward causes a slight reduction in the measured coherence resulting from imperfect phase estimation. For both the amplitude and frequency sweep, the salient features of the data are well described by simple simulations of the experiment with no free parameters aside from a global amplitude rescaling (see FIGS. 6D and 6E). These are based on the assumption of monochromatic noise that solely perturbs the frequencies of the qubits [29]. At stronger noise strengths, a slight discrepancy occurs, which likely arises from a breakdown of these assumptions.

Alongside our numerical simulations, analytic expressions can be derived for the error due to quantum projection noise (QPN) in the phase estimation step. In the absence of any correlated dephasing QPN-induced feed-forward errors modulate the data-qubit expectation values [symbol] σₓ [symbol] by f≈1 −γ²β²/(2NC²) [29]. For our experimental parameters (C=0.46, N=61, where N is the average number of loaded spectator qubits 120) we find f≈0.88, in good agreement with the numerical simulations.

In the context of quantum information processing, it is interesting to consider the requirements to reach f>>0.99. Without any change in γ or β, f=0.99 could be achieved for N=165 and C=1. At present, the value of C is limited primarily by uncorrelated dephasing of the spectator qubits, caused by thermal motion in the optical tweezers and tweezer-induced T₁ processes. Thermal motion can be reduced by additional cooling schemes and T₁ can be improved by increased detuning of the optical tweezers.

Beyond optimizing for γ≈1, f can be further improved by reducing β, at the cost of a reduced range of correctable data qubit errors, ΦD_{D,max}=±γβπ/2. This could be achieved with alternative spectator qubit states, such as magnetic-field-sensitive states.

Although here we focus on magnetic field noise, the protocol can also mitigate common-mode control errors. For instance, by co-trapping the data qubits 122 and spectator qubits 120 using the same laser system (such as a far-detuned 1064-nm laser), phase errors induced by intensity fluctuations of the trapping laser light could be corrected.

### Coherent Reloading of Spectator Qubits

In these experiments, fluorescence-based detection of the spectators involves selectively removing those in the |1 [symbol] _{Cs} state prior to imaging. Therefore, performing repetitive MCRs will continuously deplete the array. Although low-loss readout techniques exist [30, 31], finite losses always remain from both the readout itself and the trapping lifetime. Therefore, continuous operation of atom-based quantum processors will require reload and reset operations which overcome these erasure errors [32, 33]. Here, we explore two methods for reloading spectators while maintaining coherent data qubits. These build on our standard procedure, where a two-dimensional magneto-optical trap generates a beam of atoms that is laser-cooled into the tweezer array via a three-dimensional magneto-optical trap (MOT).

The first reloading approach uses a stroboscopic MOT that is applied synchronously with an XY4 sequence on the data qubits, to decouple them from the magnetic field gradient (see FIG. 7A). Without the gradient, this decoupling sequence gives

$${T}_{2}^{XY 4} = 0.45 s \qquad ( 1 )$$

With it, we find

$${T}_{2}^{XY 4} = 0.42 s , \qquad ( 3 )$$

but the functional form is modified [29]. The spectator array is reloaded on a much shorter timescale of 150(50) ms, defined as the time taken to reach 1−1/e of the asymptotic loading fraction. The pulsed MOT saturates at a loading fraction of 0.49, comparable to that achieved with the standard procedure. Residual dephasing from the field gradient can be overcome by using low inductance coils with faster switching times, and by performing decoupling pulses using a Raman laser system, which would enable ˜MHz Rabi frequencies.

In the second approach, we use polarization-gradient cooling (PGC) to load spectator qubits directly from the atomic beam without a field gradient (see FIG. 7B). This both increases the loading speed and allows an arbitrary choice of decoupling parameters: here we use a single cycle of XY8. In this reloading paradigm, the data qubit coherence time of

$${T}_{2}^{XY 8} = 0.64 s \qquad ( 5 )$$

is unchanged from the values presented in FIG. 5B and the spectator qubit array is reloaded on a timescale of 90(30) ms. The fraction of total reloaded spectator qubits is lower than in the previous method, saturating at 0.32. We hypothesize that this is limited by the 2-mm-diameter cooling beams. Incorporating larger cooling beams will likely increase the loading fraction for both approaches and would enable reloading times of a few tens of milliseconds [34]. Coherence times of ˜seconds can be achieved by using further detuned trapping light and a larger number of decoupling pulses [9].

### Discussion and Outlook

A central challenge for all quantum architectures is to increase system sizes while maintaining low physical error rates. Our demonstration of the use of spectator qubits to measure and correct correlated phase noise is a broadly applicable strategy that can be employed to reduce error rates in quantum computing platforms. Furthermore, spectator protocols could be used in conjunction with standard quantum error correction strategies to protect against correlated errors as well as increase the fidelity of operations beyond the fault-tolerance threshold. An attractive feature of this protocol is that it does not necessitate interactions (two-qubit gates), or individual spectator qubit control, reducing hardware complexity. The use of spectator qubits for noise measurements may provide opportunities in quantum sensing and metrology [22, 35, 36], and for improving clock coherence within a single device via differential spectroscopy between the data and spectator qubits [37]. Whereas here we focus on global noise, arrays of spectator qubits may also enable the detection of spatially varying noise fields which can be suppressed via local qubit addressing [24]. Careful engineering of the spectator qubits and their control sequences may improve protocol performance. For example, spectator qubits could be encoded in states with enhanced or reduced noise sensitivity to increase the phase resolution or the range of tolerable noise [25]. This can be achieved by using non-zero m_{F} states or by entangling the spectator qubits [22].

The methods demonstrated in this work constitute a set of quantum-control techniques that are essential for atom-array quantum processors, including mid-circuit readout, feed-forward operations, and reloading of auxiliary qubits while maintaining quantum data. Combining these capabilities with programmable intraspecies [9, 38] and interspecies Rydberg gates will enable auxiliary-qubit-assisted measurements as required for quantum error correction [32, 33, 39] and efficient preparation of long-range entangled states [40]. These same capabilities also enable the exploration of complex dynamical quantum behavior under continuous observation, including measurement-induced phase transitions [41].

### REFERENCES

[1]E. T. Campbell, B. M. Terhal, C. Vuillot, Nature 549, 172-179 (2017).
[2]B. M. Terhal, Rev. Mod. Phys. 87, 307-346 (2015).
[3]C. Ryan-Anderson et al., Phys. Rev. X11, 041058 (2021).
[4]L. Postler et al., Nature 605, 675-680 (2022).
[5]Y. Zhao et al., Phys. Rev. Lett. 129, 030501 (2022).
[6]S. Krinner et al., Nature 605, 669-674 (2022).
[7]R. Acharya et al., Nature 614, 676-681 (2023).
[8]M. Abobeih et al., Nature 606, 884-889 (2022).
[9]D. Bluvstein et al., Nature 604, 451-456 (2022).
[10]J. Preskill, Quantum Inf Comput. 13, 181-194 (2013).
[11]A. G. Fowler, J. M. Martinis, Phys. Rev. A 89, 032316 (2014).
[12]S. Kuhr et al., Phys. Rev. A 72, 023406 (2005).
[13]T. Monz et al., Phys. Rev. Lett. 106, 130506 (2011).
[14]C. E. Bradley et al., Phys. Rev. X 9, 031045 (2019).
[15]J. M. Boter et al., Phys. Rev. B 101, 235133 (2020).
[16]C. D. Wilen et al., Nature 594, 369-373 (2021).
[17]L. M. Vandersypen, I. L. Chuang, Rev. Mod. Phys. 76, 1037-1069 (2005).
[18]H. A. Rabitz, M. M. Hsieh, C. M. Rosenthal, Science 303, 1998-2001 (2004).
[19]T. Gullion, D. B. Baker, M. S. Conradi, J Magn. Reson. 89, 479-484 (1990).
[20]M. D. Shulman et al., Nat. Commun. 5, 5156 (2014).
[21]S. Mavadia, V. Frey, J. Sastrawan, S. Dona, M. J. Biercuk, Nat. Commun. 8, 14106 (2017).
[22]C. L. Degen, F. Reinhard, P. Cappellaro, Rev. Mod. Phys. 89, 035002 (2017).
[23]S. Majumder, L. Andreta de Castro, K. R. Brown, Npj Quantum Inf 6, 19 (2020).
[24]R. S. Gupta, L. C. Govia, M. J. Biercuk, Phys. Rev. A 102, 042611 (2020).
[25]H. Song, A. Chantasri, B. Tonekaboni, H. M. Wiseman, Phys. Rev. A. 107, L030601 (2023).
[26]K. Singh, S. Anand, A. Pocklington, J. T. Kemp, H. Bernien, Phys. Rev. X 12, 011040 (2022).
[27]E. Deist et al., Phys. Rev. Lett. 129, 203602 (2022).
[28]J. T. Zhang et al., Quantum Sci. Technol. 7, 035006 (2022).
[29]K. Singh et al., Supplementary Materials for “Mid-circuit correction of correlated phase errors using an array of spectator qubits,” Science 380, 1265 (2023)
[30]A. Fuhrmanek, R. Bourgain, Y. R. P. Sortais, A. Browaeys, Phys. Rev. Lett. 106, 133003 (2011).
[31]M. J. Gibbons, C. D. Hamley, C.-Y. Shih, M. S. Chapman, Phys. Rev. Lett. 106, 133002 (2011).
[32]I. Cong et al., Phys. Rev. X 12, 021049 (2022).
[33]Y. Wu, S. Kolkowitz, S. Puri, J. D. Thompson, Nat. Commun. 13, 4657 (2022).
[34]A. Steane, M. Chowdhury, C. Foot, JOSA B 9, 2142 (1992).
[35]I. S. Madjarov et al., Phys. Rev. X9, 041052 (2019).
[36]M. A. Norcia et al., Science 366, 93-97 (2019).
[37]M. E. Kim et al., Nat. Phys. 19, 25-29 (2023).
[38]T. M. Graham et al., Nature 604, 457-462 (2022).
[39]M. Morgado, S. Whitlock, AVS Quantum Science 3, 023501 (2021).
[40]R. Verresen, N. Tantivasadakarn, A. Vishwanath, arXiv:2112.03061 (2021).
[41]Y. Li, X. Chen, M. P. A. Fisher, Phys. Rev. B 98, 205136 (2018).

### Combinations of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) A quantum-computing method includes executing a data quantum circuit with a plurality of data qubits. All of the plurality of data qubits are of the same first type of quantum system having a first plurality of transitions. Each of the plurality of data qubits is in a respective one of a first plurality of coherent superposition states during at least part of said executing the data quantum circuit. The quantum-computing method also includes executing a spectator quantum circuit with a plurality of spectator qubits. All of the plurality of spectator qubits are of the same second type of quantum system having a second plurality of transitions. Each of the plurality of spectator qubits is in a respective one of a second plurality of coherent superposition states during at least part of said executing the spectator quantum circuit. Said executing the spectator quantum circuit includes simultaneously illuminating, while the plurality of data qubits are in the first plurality of coherent superposition states, the plurality of spectator qubits and the plurality of data qubits with a coherent radiation field that is (i) far detuned from all of the first plurality of transitions and (ii) resonant with a resonant transition of the second plurality of transitions.

(A2) In the quantum-computing method denoted (A1), said executing the data quantum circuit includes simultaneously illuminating, while the plurality of spectator qubits are in the second plurality of coherent superposition states, the plurality of spectator qubits and the plurality of data qubits with a coherent radiation field that is (i) resonant with one of the first plurality of transitions and (ii) far detuned from all of the second plurality of transitions.

(A3) In either of the quantum-computing methods denoted (A1) and (A2), the first type of quantum system is a first atomic species and the second type of quantum system is a second atomic species that is different from the first atomic species.

(A4) In any of the quantum-computing methods denoted (A1) to (A3), said executing the spectator quantum circuit finishes after said executing the data quantum circuit starts and before said executing the data quantum circuit finishes.

(A5) In any of the quantum-computing methods denoted (A1) to (A4), the quantum-computing method further includes trapping the plurality of data qubits to form a data array and trapping the plurality of spectator qubits to form a spectator array. Said driving occurs while the plurality of data qubits are trapped and the plurality of spectator qubits are trapped.

(A6) In the quantum-computing method denoted (A5), the spectator array is at least partially spatially overlapped with the data array.

(A7) In either of the quantum-computing methods denoted (A5) and (A6), each of the data array and the spectator array being two-dimensional.

(A8) In any of the quantum-computing methods denoted (A5) to (A7), said trapping the plurality of data qubits includes trapping the plurality of data qubits in a first optical lattice. Said trapping the plurality of spectator qubits includes trapping the plurality of spectator qubits in a second optical lattice.

(A9) In any of the quantum-computing methods denoted (A1) to (A8), the plurality of spectator qubits are proximate to the plurality of data qubits.

(A10) In the quantum-computing method denoted (A9), the plurality of spectator qubits are interspersed among the plurality of data qubits.

(A11) In any of the quantum-computing methods denoted (A1) to (A10), the first type of quantum system includes first, second, and third quantum states. Each of the first plurality of coherent superposition states is a linear combination of the first and second quantum states. The second type of quantum system includes fourth, fifth, and sixth quantum states. Each of the second plurality of coherent superposition states is a linear combination of the fourth and fifth quantum states. The resonant transition connects the fifth and sixth quantum states with a resonant transition energy. The first plurality of transitions includes a first transition that connects the second and third quantum states with a first transition energy that is different from the resonant transition energy.

(A12) In the quantum-computing method denoted (A11), each of the first transition and the resonant transition is an electric-dipole transition or a magnetic-dipole transition.

(A13) In either of the quantum-computing methods denoted (A11) and (A12), the first plurality of transitions includes a second transition that connects the first and third quantum states with a second transition energy that is different from the first transition energy and the resonant transition energy. The second plurality of transitions includes a third transition that connects the fourth and sixth quantum states with a third transition energy that is different from the first transition energy, the second transition energy, and the resonant transition energy.

(A14) In any of the quantum-computing methods denoted (A11) to (A13), each of the first and second quantum states is a magnetic sublevel of a ground hyperfine state of a first atomic species, the third quantum state is a magnetic sublevel of an excited hyperfine state of the first atomic species, each of the fourth and fifth quantum states is a magnetic sublevel of a ground hyperfine state of a second atomic species that is different from the first atomic species, and the sixth quantum state is a magnetic sublevel of an excited hyperfine state of the second atomic species.

(A15) In any of the quantum-computing methods denoted (A1) to (A14), said executing the data quantum circuit and said executing the spectator quantum circuit start simultaneously.

(A16) In any of the quantum-computing methods denoted (A1) to (A15), said executing the spectator quantum circuit includes measuring the plurality of spectator qubits to generate spectator-qubit measurement data.

(A17) In the quantum-computing method denoted (A16), said measuring the plurality of spectator qubits includes imaging the plurality of spectator qubits.

(A18) In either of the quantum-computing methods denoted (A16) and (A17), the quantum-computing method further includes processing the spectator-qubit measurement data to estimate a spectator-qubit phase that was accumulated by the plurality of spectator qubits during said executing the spectator quantum circuit.

(A19) In the quantum-computing method denoted (A18), the quantum-processing method further includes controlling, after said processing, a data-qubit phase of the plurality of data qubits to correct the data-qubit phase based on the spectator-qubit phase.

(A20) In the quantum-computing method denoted (A19), said controlling finishes before said executing the spectator quantum circuit finishes.

(A21) In any of the quantum-computing methods denoted (A1) to (A20), the quantum-computing method further includes loading, during said executing the data quantum circuit, the plurality of spectator qubits into a spectator array.

(A22) In the quantum-computing method denoted (A21), said loading finishes before said executing the data quantum circuit finishes.

(A23) In the quantum-computing method denoted (A22), said loading includes cooling the plurality of spectator qubits in a magneto-optic trap that spatially overlaps the spectator array. Said loading also includes transferring, after said cooling, the plurality of spectator qubits from the magneto-optic trap into the spectator array by turning off the magneto-optic trap.

(A24) In the quantum-computing method denoted (A22), said executing the data quantum circuit includes applying a dynamical decoupling sequence of pulses. Said cooling the plurality of spectator qubits occurs between a pair of sequential pulses of the dynamical decoupling sequence

(A25) In any of the quantum-computing methods denoted (A21) to (A24), said loading includes cooling the plurality of spectator qubits using polarization gradient cooling. The plurality of spectator qubits are spatially overlapped with the spectator array. Said loading also includes transferring, after said cooling, the plurality of spectator qubits into the spectator array by turning off the polarization gradient cooling.

(B1) A quantum-computing system includes a data-qubit controller configured to execute a data quantum circuit with a plurality of data qubits. All of the plurality of data qubits are of the same first type of quantum system having a first plurality of transitions. Each of the plurality of data qubits is in a respective one of a first plurality of coherent superposition states during execution of at least part of the data quantum circuit. The quantum-computing system also includes a spectator-qubit controller configured to execute a spectator quantum circuit with a plurality of spectator qubits. All of the plurality of spectator qubits are of the same second type of quantum system having a second plurality of transitions. Each of the plurality of spectator qubits is in a respective one of a second plurality of coherent superposition states during execution of at least part of the spectator quantum circuit. The spectator-qubit controller includes a laser configured to simultaneously illuminate, while the plurality of data qubits are in the first plurality of coherent superposition states, the plurality of spectator qubits and the plurality of data qubits with a coherent radiation field that is (i) far detuned from all of the first plurality of transitions and (ii) resonant with a resonant transition of the second plurality of transitions.

(B2) In the quantum-computing system denoted (B1), the data-qubit controller includes an additional laser configured to simultaneously illuminate, while the plurality of spectator qubits are in the second plurality of coherent superposition states, the plurality of spectator qubits and the plurality of data qubits with an additional coherent radiation field that is (i) resonant with one of the first plurality of transitions and (ii) far detuned from all of the second plurality of transitions.

(B3) In either of the quantum-computing systems denoted (B1) and (B2), the first type of quantum system is a first atomic species and the second type of quantum system is a second atomic species different from the first atomic species.

(B4) In any of the quantum-computing systems denoted (B1) to (B3), the spectator-qubit controller is configured to execute the spectator quantum circuit such that the spectator quantum circuit finishes after the data quantum circuit starts and before the data quantum circuit finishes.

(B5) In any of the quantum-computing systems denoted (B1) to (B4), the quantum-computing system further includes a data-array generator configured to trap the plurality of data qubits to form a data array and a spectator-array generator configured to trap the plurality of spectator qubits to form a spectator array. The spectator-qubit controller is configured to control the laser such that the coherent radiation field drives the plurality of spectator qubits and the plurality of data qubits while the plurality of spectator qubits are trapped and the plurality of data qubits are trapped.

(B6) In the quantum-computing system denoted (B5), the spectator array is at least partially spatially overlapped with the data array.

(B7) In either of the quantum-computing systems denoted (B5) and (B6), each of the data array and the spectator array being two-dimensional.

(B8) In any of the quantum-computing systems denoted (B5) to (B7), the data-array generator includes a first trapping laser configured to generate a first optical lattice, the data-array generator is configured to trap the plurality of data qubits in the first optical lattice, the spectator-array generator includes a second trapping laser configured to generate a second optical lattice, and the spectator-array generator is configured to trap the plurality of spectator qubits in the second optical lattice.

(B9) In any of the quantum-computing systems denoted (B1) to (B8), the plurality of spectator qubits are proximate to the plurality of data qubits.

(B10) In the quantum-computing system denoted (B9), the plurality of spectator qubits are interspersed among the plurality of data qubits.

(B11) In any of the quantum-computing systems denoted (B1) to (B10), the first type of quantum system includes first, second, and third quantum states. Each of the first plurality of coherent superposition states is a linear combination of the first and second quantum states. The second type of quantum system includes fourth, fifth, and sixth quantum states. Each of the second plurality of coherent superposition states is a linear combination of the fourth and fifth quantum states. The resonant transition connects the fifth and sixth quantum states with a resonant transition energy. The first plurality of transitions includes a first transition that connects the second and third quantum states with a first transition energy that is different from the resonant transition energy.

(B12) In the quantum-computing system denoted (B11), each of the first transition and the resonant transition is an electric-dipole transition or a magnetic-dipole transition.

(B13) In either of the quantum-computing systems denoted (B11) and (B12), the first plurality of transitions includes a second transition that connects the first and third quantum states with a second transition energy that is different from the first transition energy and the resonant transition energy. The second plurality of transitions includes a third transition that connects the fourth and sixth quantum states with a third transition energy that is different from the first transition energy, the second transition energy, and the resonant transition energy.

(B14) In any of the quantum-computing systems denoted (B11) to (B13), each of the first and second quantum states is a magnetic sublevel of a ground hyperfine state of a first atomic species, the third quantum state is a magnetic sublevel of an excited hyperfine state of the first atomic species, each of the fourth and fifth quantum states is a magnetic sublevel of a ground hyperfine state of a second atomic species that is different from the first atomic species, and the sixth quantum state is a magnetic sublevel of an excited hyperfine state of the second atomic species.

(B15) In any of the quantum-computing systems denoted (B1) to (B14), one or both of the data-qubit controller and the spectator-qubit controller are configured such that execution of the data quantum circuit occurs simultaneously with execution of the spectator quantum circuit.

(B16) In any of the quantum-computing systems denoted (B1) to (B15), the spectator-qubit controller includes a camera. The spectator-qubit controller is configured to image the plurality of spectator qubits using the camera.

(B17) In the quantum-computing system denoted (B16), the quantum-computing system further includes a signal processor configured to process an image received from the camera to estimate a spectator-qubit phase that was accumulated by the plurality of spectator qubits during said execution of the spectator quantum circuit.

(B18) In the quantum-computing system denoted (B17), the signal processor is configured to instruct the data-qubit controller to control a data-qubit phase of the plurality of data qubits to correct the data-qubit phase based on the spectator-qubit phase.

(B19) In the quantum-computing system denoted (B18), the data-qubit controller is configured to finish controlling the data-qubit phase before the spectator quantum circuit finishes.

(B20) In any of the quantum-computing systems denoted (B1) to (B19), the quantum-computing system includes a spectator-qubit loader configured to load the plurality of spectator qubits into a spectator array during execution of the data quantum circuit.

(B21) In the quantum-computing system denoted (B20), the spectator-qubit loader is configured to finish loading the plurality of spectator qubits into the spectator array before execution of the data quantum circuit finishes.

(B22) In the quantum-computing system denoted (B21), the spectator-qubit loader includes one or more lasers configured to create a magneto-optic trap that spatially overlaps the spectator array. The spectator-qubit loader is configured to cool the plurality of spectator qubits in the magneto-optic trap and transfer the plurality of spectator qubits, after cooling, from the magneto-optic trap into the spectator array by turning off the magneto-optic trap.

(B23) In the quantum-computing system denoted (B22), the data-qubit controller is configured to apply a dynamical decoupling sequence of pulses as part of the data quantum circuit. The spectator-qubit loader is configured to cool the plurality of spectator qubits between a pair of sequential pulses of the dynamical decoupling sequence.

(B24) In any of the quantum-computing systems denoted (B20) to (B23), the spectator-qubit loader includes one or more lasers configured to implement polarization gradient cooling of the plurality of spectator qubits while the plurality of spectator qubits are spatially overlapped with the spectator array. The spectator-qubit loader is configured to transfer the plurality of spectator qubits, after cooling, into the spectator array by turning off the polarization gradient cooling.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A quantum-computing method, comprising:
executing a data quantum circuit with a plurality of data qubits, all of the plurality of data qubits being of the same first type of quantum system having a first plurality of transitions, each of the plurality of data qubits being in a respective one of a first plurality of coherent superposition states during at least part of said executing the data quantum circuit; and
executing a spectator quantum circuit with a plurality of spectator qubits, each of the plurality of spectator qubits being of the same second type of quantum system having a second plurality of transitions, each of the plurality of spectator qubits being in a respective one of a second plurality of coherent superposition states during at least part of said executing the spectator quantum circuit;
wherein said executing the spectator quantum circuit includes simultaneously driving, while the plurality of data qubits are in the first plurality of coherent superposition states, the plurality of spectator qubits and the plurality of data qubits with a coherent radiation field that is (i) far detuned from all of the first plurality of transitions and (ii) resonant with a resonant transition of the second plurality of transitions.

2. The quantum-computing method of claim 1, wherein said executing the data quantum circuit includes simultaneously driving, while the plurality of spectator qubits are in the second plurality of coherent superposition states, the plurality of spectator qubits and the plurality of data qubits with a coherent radiation field that is (i) resonant with one of the first plurality of transitions and (ii) far detuned from all of the second plurality of transitions.

3. The quantum-computing method of claim 1, wherein:
the first type of quantum system is a first atomic species; and
the second type of quantum system is a second atomic species that is different from the first atomic species.

4. The quantum-computing method of claim 1, wherein said executing the spectator quantum circuit finishes after said executing the data quantum circuit starts and before said executing the data quantum circuit finishes.

5. The quantum-computing method of claim 1,
further comprising:
trapping the plurality of data qubits to form a data array; and
trapping the plurality of spectator qubits to form a spectator array;
wherein said driving occurs while the plurality of data qubits are trapped and the plurality of spectator qubits are trapped.

6-8. (canceled)

9. The quantum-computing method of claim 1, the plurality of spectator qubits being proximate to the plurality of data qubits.

10. (canceled)

11. The quantum-computing method of claim 1, wherein:
the first type of quantum system comprises first, second, and third quantum states, each of the first plurality of coherent superposition states being a linear combination of the first and second quantum states;
the second type of quantum system comprises fourth, fifth, and sixth quantum states, each of the second plurality of coherent superposition states being a linear combination of the fourth and fifth quantum states;
the resonant transition connects the fifth and sixth quantum states with a resonant transition energy; and
the first plurality of transitions includes a first transition that connects the second and third quantum states with a first transition energy that is different from the resonant transition energy.

12-14. (canceled)

15. The quantum-computing method of claim 1, wherein said executing the data quantum circuit and said executing the spectator quantum circuit start simultaneously.

16. The quantum-computing method of claim 1, wherein said executing the spectator quantum circuit includes measuring the plurality of spectator qubits to generate spectator-qubit measurement data.

17. (canceled)

18. The quantum-computing method of claim 16, further comprising processing the spectator-qubit measurement data to estimate a spectator-qubit phase that was accumulated by the plurality of spectator qubits during said executing the spectator quantum circuit.

19. The quantum-computing method of claim 18, further comprising controlling, after said processing, a data-qubit phase of the plurality of data qubits to correct the data-qubit phase based on the spectator-qubit phase.

20-25. (canceled)

26. A quantum-computing system, comprising:
a data-qubit controller configured to execute a data quantum circuit with a plurality of data qubits, all of the plurality of data qubits being of the same first type of quantum system having a first plurality of transitions, each of the plurality of data qubits being in a respective one of a first plurality of coherent superposition states during execution of at least part of the data quantum circuit; and
a spectator-qubit controller configured to execute a spectator quantum circuit with a plurality of spectator qubits, all of the plurality of spectator qubits being of the same second type of quantum system having a second plurality of transitions, each of the plurality of spectator qubits being in a respective one of a second plurality of coherent superposition states during execution of at least part of the spectator quantum circuit;
wherein the spectator-qubit controller comprises a laser configured to simultaneously drive, while the plurality of data qubits are in the first plurality of coherent superposition states, the plurality of spectator qubits and the plurality of data qubits with a coherent radiation field that is (i) far detuned from all of the first plurality of transitions and (ii) resonant with a resonant transition of the second plurality of transitions.

27. The quantum-computing system of claim 26, the data-qubit controller comprising an additional laser configured to simultaneously drive, while the plurality of spectator qubits are in the second plurality of coherent superposition states, the plurality of spectator qubits and the plurality of data qubits with an additional coherent radiation field that is (i) resonant with one of the first plurality of transitions and (ii) far detuned from all of the second plurality of transitions.

28. The quantum-computing system of claim 26, wherein:
the first type of quantum system is a first atomic species; and
the second type of quantum system is a second atomic species different from the first atomic species.

29. The quantum-computing system of claim 26, the spectator-qubit controller being configured to execute the spectator quantum circuit such that the spectator quantum circuit finishes after the data quantum circuit starts and before the data quantum circuit finishes.

30. The quantum-computing system of claim 26, further comprising:
a data-array generator configured to trap the plurality of data qubits to form a data array; and
a spectator-array generator configured to trap the plurality of spectator qubits to form a spectator array;
wherein the spectator-qubit controller is configured to control the laser such that the coherent radiation field drives the plurality of spectator qubits and the plurality of data qubits while the plurality of spectator qubits are trapped and the plurality of data qubits are trapped.

31-33. (canceled)

34. The quantum-computing system of claim 26, the plurality of spectator qubits being proximate to the plurality of data qubits.

35. (canceled)

36. The quantum-computing system of claim 26, wherein:
the first type of quantum system comprises first, second, and third quantum states, each of the first plurality of coherent superposition states being a linear combination of the first and second quantum states;
the second type of quantum system comprises fourth, fifth, and sixth quantum states, each of the second plurality of coherent superposition states being a linear combination of the fourth and fifth quantum states;
the resonant transition connects the fifth and sixth quantum states with a resonant transition energy; and
the first plurality of transitions includes a first transition that connects the second and third quantum states with a first transition energy that is different from the resonant transition energy.

37-40. (canceled)

41. The quantum-computing system of claim 26, wherein:
the spectator-qubit controller includes a camera;
the spectator-qubit controller is configured to image the plurality of spectator qubits using the camera; and
the quantum-computing system further includes a signal processor configured to process an image received from the camera to estimate a spectator-qubit phase that was accumulated by the plurality of spectator qubits during said execution of the spectator quantum circuit.

42. (canceled)

43. The quantum-computing system of claim 41, the signal processor being configured to instruct the data-qubit controller to control a data-qubit phase of the plurality of data qubits to correct the data-qubit phase based on the spectator-qubit phase.

44-49. (canceled)
